(19) United States
(12) Patent Application Publication
(10) Pub. No.: US 2004/0085980 A1
(43) Pub. Date: May 6, 2004

(54) System and method for maintaining transaction cache consistency in mobile computing environment

(75) Inventor: Sang Keun Lee, Seoul (KR)

Correspondence Address: JONATHAN Y. KANG, ESQ., LEE & HONG P.C., 11th Floor, 221 N. Figueroa, Los Angeles, CA, 90012-2001, US

(73) Assignee: LG Electronics Inc.

(21) Appl. No.: 10/613,936

(22) Filed: Jul. 2, 2003

(30) Foreign Application Priority Data
Oct. 31, 2002 (KR) 2002-67237

(51) Int. Cl. H04L 12/56

(52) U.S. Cl. 370/412; 370/310

(57) ABSTRACT

A system for maintaining a transaction cache consistency in a mobile communication network is provided. The system comprises: a mobile server for periodically broadcasting an invalidation report (IR) message; and a mobile client for updating data stored in a transaction cache based upon information included in the IR message, and for confirming execution of a transaction.

### CROSS REFERENCE TO RELATED APPLICATION

Pursuant to 35 U.S.C. § 119(a), this application claims the benefit of earlier filing date and right of priority to Korean Patent Application No. 2002-67237, filed on Oct. 31, 2002, the content of which is hereby incorporated by reference herein in its entirety.

### BACKGROUND OF THE INVENTION

1. Field of the Invention

The present invention relates to a mobile computing system and, more particularly, to a system and method for maintaining transaction cache consistency in a mobile computing environment.

2. Description of the Related Art

Due to the development of radio communication techniques and popularity of mobile communication devices, a mobile communication environment has been created in which users can be provided with various information while moving.

A transaction in the mobile computing environment is used in a case where a process such as an order made by a user through a mobile terminal or a bill issuing operation is required but a portion of a sub-operation fails so that the overall operation is not processed.

That is, the transaction is a process function used for the successfully executed operation as portions of sub-operations are all successful. Thus, one transaction is made up by one or more computation units.

The processing of transaction in the mobile computing environment is restricted by the mobility of a host, frequent disconnection, limited bandwidth, battery capacity, or the like. Therefore, in order to reduce the use of the bandwidth as much as possible in the mobile computing environment and improve response time of a mobile transaction, a caching technique has been proposed in which a mobile host caches frequently accessed data.

FIG. 1 is an example of a general configuration of a mobile computing network. The mobile computing network roughly consists of a fixed host which is connected by wire to a fixed network (a wired network) and a mobile host which is movable.

The fixed host having a radio communication interface and providing a service is mobile server 20, and a mobile host in radio communication with the mobile server 20 is called a mobile client 10.

The zone in which a mobile server 20 can provide a service is called a cell, and mobile clients 10 located in the same cell communicate with the same mobile server 20 through a radio channel. The cell can be implemented by a cellular connection or by a wireless LAN (local area network).

In general, the mobile server 20 has a wide communication bandwidth and abundant battery power. Since the mobile server 20 communicates by way of a wired network 30, a reliable communication channel can be established. Meanwhile, the mobile client 10 has a limited bandwidth and battery life and communicates by way of a wireless network, so that it is less reliable.

The mobile client 10 can perform a transaction by using a cached data even while being moved or disconnected. The transaction submitted to the mobile client 10 is called a mobile transaction.

If the data stored in the cache of the mobile client 10 is updated by the mobile server 20, the mobile server 20 broadcasts an invalidation report (IR) message informing that the cached data has been updated to the mobile client 10 in order to maintain the cache consistency of the mobile client 10 with the mobile server 20.

However, since the mobile communication network has a limited bandwidth, frequent message exchanges between the mobile client 10 and the mobile server 20, can result in heavy data traffic that substantially reduces available bandwidth.

Thus, it is preferred that the mobile server 20 reduces the communication as much as possible with the mobile client 10 when it informs the mobile client 10 whether the data has been updated. Therefore, the mobile server 20 collects the information updated for a certain period of time and periodically broadcasts the invalidation report message to the mobile client 10. The mobile client 10 does not know whether the data has been updated in the mobile server 20 until it receives the periodically broadcasted invalidation report message.

In the case that the cached data is updated in the mobile server 20, since the mobile client 10 does not know whether the data has been updated until it receives a broadcast on the invalidation report message, the cache consistency of the mobile client 10 is not guaranteed and the serializable performance of the mobile transaction is not also guaranteed.

In addition, in the conventional mobile computing environment, when the mobile client executes a read-only mobile transaction and requests confirmation of the executed read-only mobile transaction from the mobile server, the mobile server determines whether to confirm or withdraw the read-only mobile transaction according to the confirmation request and informs the mobile client.

The mobile client confirms or withdraws the read-only mobile transaction according to the information provided by the mobile server. Therefore, in the conventional mobile computing environment, a large amount of transmission and reception messages between the mobile server and the mobile client take place. This amount of transmission interferes with the effective use of the limited bandwidth.

In addition, since the read-only mobile transactions executed on the mobile client require confirmation or withdrawal by the mobile server, the response time is too long. Moreover, since the mobile server is required to determine the confirmation of the mobile transaction executed in the mobile client, an additional load limits the availability of communication bandwidth.

Thus, a method and system is needed to overcome the above-discussed problems associated with bandwidth limitation in a cellular communication network.

### SUMMARY OF THE INVENTION

In accordance with one aspect of the invention, a mobile client terminal for maintaining transaction cache consistency in a mobile communication network is in communication with a mobile server configured to periodically broadcast an invalidation report (IR) message; wherein the mobile client terminal updates data stored in a transaction cache based upon information included in the IR message, and confirms execution of a transaction.

The mobile client terminal comprises a transaction execution module for executing the transaction; a cache invalidation module for updating the transaction cache based on the information included in the IR message; a cache consistency module for maintaining transaction cache consistency by canceling transactions which are invalid according to the information included in the IR message; and a confirmation module for confirming or delaying execution of the transaction, depending on a time stamp of data accessed by the transaction execution module.

In one embodiment, the mobile server comprises an IR module for periodically broadcasting the IR message; and a data set providing module for providing data to the mobile client terminal in response to an immediate caching request from the mobile client. The IR message comprises a broadcast time stamp for indicating a broadcast time; updated data; and an update time stamp of a transaction confirming the updated data.

At least one data is associated with the transaction, the data having a time stamp, wherein if the data associated with the transaction has a time stamp identical to time stamps of other data associated with the transaction, the mobile client terminal immediately confirms the transaction; and if the data associated with the transaction does not have a time stamp identical to time stamps of other data associated with the transaction, the mobile client terminal defers confirming the transaction until another IR message received by the mobile client.

Data stored in the transaction cache is associated with a cache time stamp, and if execution of the transaction updates the data, the mobile server updates the cache time stamp.

In accordance with another embodiment, a method for maintaining transaction cache consistency for a mobile terminal in a mobile communication environment, comprises executing a read-only transaction requesting data; updating data stored in a cache of the mobile terminal in response to receiving an invalidation report (IR) message; and confirming the executed read-only transaction. The IR message is periodically broadcast by a mobile server, wherein the IR message comprises a broadcast time stamp; updated data; and an update time stamp associated with the updated data. The update time stamp indicates when the updated data was last confirmed.

The step of updating data stored in the cache comprises deleting data stored in the cache, if the IR message is not received within a broadcast period; comparing an update time stamp of data received in the IR message with a cache time stamp of corresponding data stored in the cache, if the data received in the IR message is already stored in the cache and the IR message is received within the broadcast period; and replacing data stored in the cache with the data received in the IR message and associating with the data received in the IR message a cache time stamp equal to a broadcast time stamp of the IR message, if the update time stamp of the data received is after the cache time stamp of corresponding data stored in the cache.

The method further may comprise preventing execution of the read-only transaction associated with data invalidated in accordance with the IR message. The step of confirming comprises determining whether all data requested by the read-only transaction have equal cache time stamps, immediately confirming the read-only transaction, if all data have equal cache time stamps; and delaying confirmation of the read-only transaction until a second IR message is received, if all data do not have equal cache time stamps.

The method in certain embodiments further comprises confirming the read-only transaction, if the read-only transaction does not include data invalidated based on the IR message; and canceling the read-only transaction, if the read-only transaction includes data invalidated based on the IR message.

In accordance with another embodiment, the method for updating transaction -cache consistency in a mobile communication environment, the method comprises the steps of periodically broadcasting an invalidation report (IR) message from a mobile server to a mobile client; and executing a read-only transaction, comprising a request for data, by using an optimistic concurrency control with timestamp span (OCC-UTS2) protocol.

The step of executing the read-only transaction comprises determining whether requested data is stored in a transaction cache; processing the requested data in the transaction cache, if the requested data is stored in the cache; and retrieving the requested data from a mobile server, if the requested data is not stored in the transaction cache. The requested data stored in the transaction cache is associated with a cache time stamp. In some embodiments the method further comprises receiving an IR message associated with the requested data, wherein the IR message includes corresponding data associated with an update time stamp; selecting the requested data stored in the transaction cache, if the update time stamp matches the cache time stamp; and waiting to receive another IR message, if the update time stamp does not match the cache time stamp.

The method may further comprise replacing data stored in the transaction cache with the corresponding data in the IR message, if the corresponding data included in the IR message is associated with an update time stamp that is after the cache time stamp associated with the data stored in the cache. In some embodiments the method comprises confirming the read-only transaction immediately, if all data requested by the executed read-only transaction have same cache time stamps; and delaying confirming the read-only transaction until another IR message is received, if all data requested by the executed read-only transaction do not have the same cache time stamps.

In accordance with yet another embodiment, a mobile communication network comprises a mobile server and mobile client terminals in communication with each other in at least one cell of the mobile communication network, wherein each mobile client terminal comprises a transaction cache, and wherein the transaction cache comprises data associated with a cache time stamp, the mobile client terminal comprising logic code embedded in a recording medium for execution by a microcontroller, wherein the execution of the logic code causes the microcontroller to perform the following actions receiving a request for data to be used in a transaction; determining whether the data is stored in the transaction cache; using the data if the data is stored in the transaction cache to execute the transaction, wherein the data stored in the transaction cache is associated with a cache time stamp; retrieving the data from the mobile server, if the data is not stored in the transaction cache, and storing the data in the transaction cache in association with a corresponding cache time stamp; determining if an invalidation report (IR) message includes validation information associated with the data, the validation information including an update time stamp associated with the data; validating the data as stored in the cache, if the update time stamp is before the cache time stamp; and updating the requested data, if the update time stamp is after the cache time stamp.

### BRIEF DESCRIPTION OF THE DRAWINGS

The invention will be described in detail with reference to the following drawings in which like reference numerals refer to like elements wherein:

FIG. 1 illustrates system configuration of a general mobile communications network;

FIG. 2 illustrates the executable of software modules of a mobile server and a mobile client in accordance with one embodiment of the invention;

FIG. 3 is a flow diagram of a method for executing a read-only mobile transaction by the mobile client in accordance with one embodiment of the invention;

FIGS. 4A and 4B are flow diagrams of a method for invalidating a transaction cache of the mobile client and checking a consistency in accordance with embodiment of the invention; and

FIG. 5 is a flow diagram of a method for confirmation of the read-only mobile transaction by the mobile client in accordance with one embodiment of the present invention.

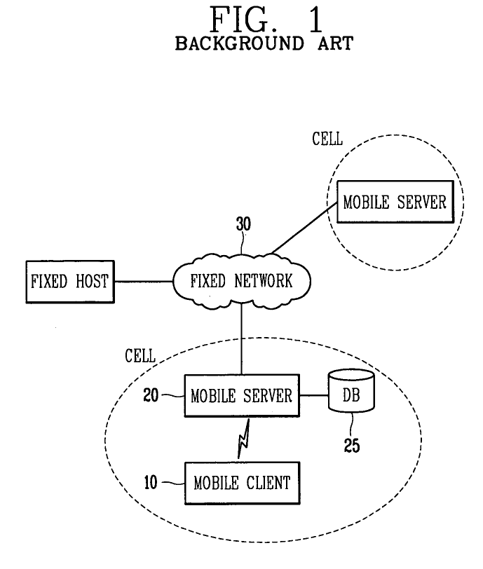

### DETAILED DESCRIPTION OF THE PREFERRED EMBODIMENTS

Since transactions in a mobile communication system can be simultaneously performed, a concurrency control is required to manage execution of a plurality of transactions that occur concurrently. An optimistic approach is one of general methods for controlling a concurrency, and is based on the assumption that most of database operations do not collide with each other. This method is preferred for a read-only transaction made up by operations of reading or inquiring a database.

In addition, since message exchange between a mobile client and a mobile server can be minimized, the present inventions adopts the optimistic concurrency control. Moreover, the present invention proposes an optimistic concurrency control with timestamp span (OCC-UTS²) protocol to facilitate checking of a transaction cache consistency and invalidation and allow the mobile client to adopt an independent transaction confirmation approach.

A preferred embodiment of the present invention will now be described with reference to the accompanying drawings.

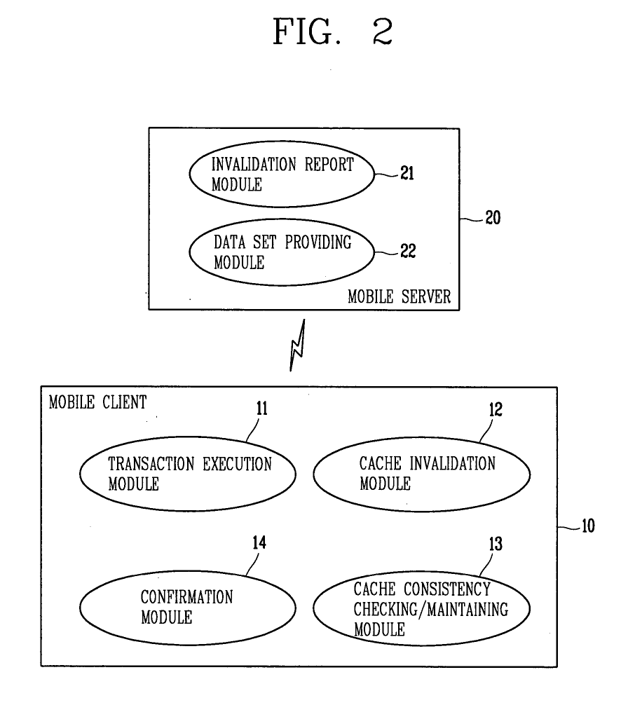

As shown in FIG. 2, in accordance with one aspect of the invention, a transaction cache consistency maintaining system comprises: a mobile server 20 for periodically broadcasting an invalidation report; and a mobile client 10 for executing a read-only mobile transaction, checking invalidation and consistency of a cache upon receiving the invalidation report, and confirming the read-only mobile transaction independently.

The cache data can comprise data and an update time stamp or a cache time stamp for the data, for example. The mobile server 20 includes an invalidation report module 21 for periodically broadcasting an invalidation report (IR) message; and a data set providing module 22 for providing a data set upon receiving an instant caching request from the mobile client 10.

The IR message has a broadcast time stamp (tsᵢ) and includes several pairs of updated data and update time stamps. The broadcast time stamp (tsᵢ) indicates a time when the IR message is broadcasted (tsᵢ=iL), wherein ‘L’ indicates a broadcast period. The update time stamp indicates a confirmation time stamp of the transaction which has the data last updated. The IR message is used to check data invalidation and consistency of a transaction cache in the mobile client 10. The data set includes a valid data and an update time stamp of the valid data.

The mobile client 10 includes a transaction execution module 11 for executing a read-only mobile transaction; a cache invalidation module 12 for checking an invalidation of a transaction cache by using the periodically received invalidation report message; a cache consistency checking/maintaining module 13 for withdrawing transactions which use invalidated data to maintain a transaction cache consistency; and a confirmation module 14 for performing an immediate validation and a delayed validation by using a cache time stamp associated with the data to which the transaction executing module 11 has received and processed. In some embodiments the immediate validation method comprises, for example, confirmation of the read-only transaction, if all the data accessed by the transaction execution process 11 has the same cache time stamp.

The delay validation method delays confirmation of the read-only mobile transaction until the next IR message is reached, if all the data processed by the transaction execution module 11 do not have the same cache time stamp. After the next IR message is received, if none of the data in the reading set is invalidated and deleted from the cache, the mobile client 10 can confirm the read-only mobile transaction. In one embodiment, a reading set is a set of data undergoing a reading operation by the read-only mobile transaction.

To maintain transaction cache consistency, the mobile server 20 assigns the same update time stamp to corresponding data items when one transaction updates several data. A mobile client 10 can confirm a transaction when all the accessed data have the same update time stamp.

In addition, the mobile server 20 periodically broadcasts the IR message through a radio communication interface in order to inform the mobile client 10 of the information on the updated data. When the read-only mobile transaction is submitted, the mobile client 10 draws back the data cached in the transaction cache and executes the read-only mobile transaction. When an IR message is received, the mobile client 10 checks invalidation and consistency of the transaction cache based on the IR message. The mobile client 10 attempts to confirm the read-only mobile transaction independently, thereafter.

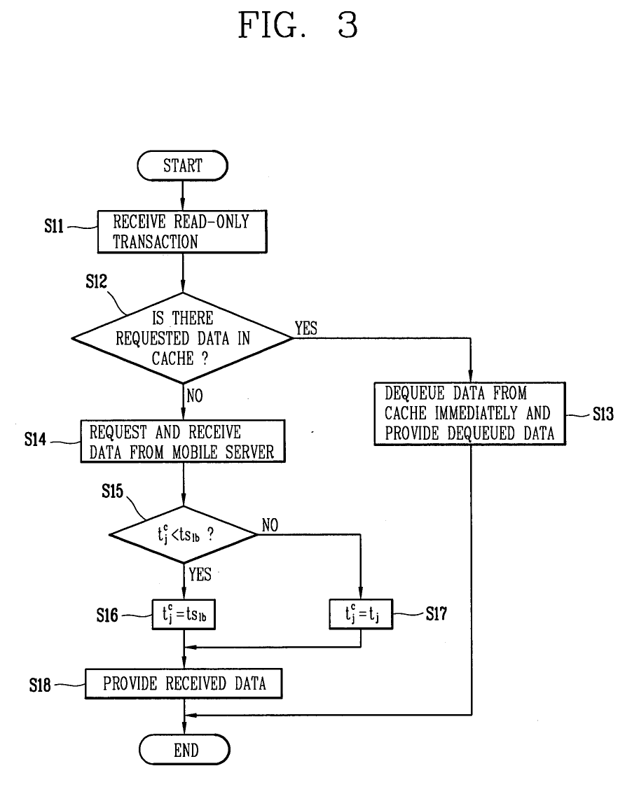

Referring to FIG. 3, when read-only mobile transaction is submitted to the mobile client 10 (S11), the transaction execution module 11 checks whether the data requested by the read-only mobile transaction exists in the transaction cache (S12).

If the requested data is in the cache, the transaction execution module 11 withdraws the requested data from the cache and provides it to the read-only mobile transaction (S13).

If, however, the requested data does not exist in the cache, the transaction execution module 11 transmits the read-only mobile transaction to the mobile server 20 and requests the data. Then, the data set providing module 22 of the mobile server 20 transmits the corresponding data set to the mobile client 10. The corresponding data set includes the requested data (j) and an update time stamp of the data (tⱼ).

The mobile client 10 receives the data set from the mobile server 20 (S14), loads the data of the received data set to the cache, and changes the cache time stamp of the data accordingly (S15-S17).

The transaction execution module 11 of the mobile client 10 compares the update time stamp (tⱼ) of the data set and the last IR time stamp (that is, a broadcast time stamp of the last received IR:ts_{lb}) (S15).

If the update time stamp (tⱼ) of the data set is prior to the last IR time stamp (ts_{lb}), the transaction execution process 11 assigns a cache time stamp (t^{c}ⱼ) for the data loaded to the cache as the last IR time stamp (ts_{lb}) (S16).

If, however, the update time stamp (tⱼ) of the data set is not prior to the last IR time stamp (ts_{lb}), the transaction execution process 11 assigns the cache time stamp (t^{c}ⱼ) of the data as the update time stamp (tⱼ) (S17).

In this manner, the mobile client receives data from the mobile server 20, immediately caches it, changes the cache time stamp of the cached data to maintain the consistency of the transaction cache, and then provides the cached data to the read-only mobile transaction (S18).

While the mobile client 10 is processing the execution step of the read-only mobile transaction, if it receives the IR message which is periodically broadcasted by the mobile server 20, the mobile client 10 performs the cache invalidation processing and the data consistency checking by using the IR message. Accordingly, upon periodically receiving the IR message, the mobile client 10 periodically performs the cache invalidation processing and the cache data consistency checking. When the read-only mobile transaction is executed, the mobile client 10 independently confirms the read-only mobile transaction.

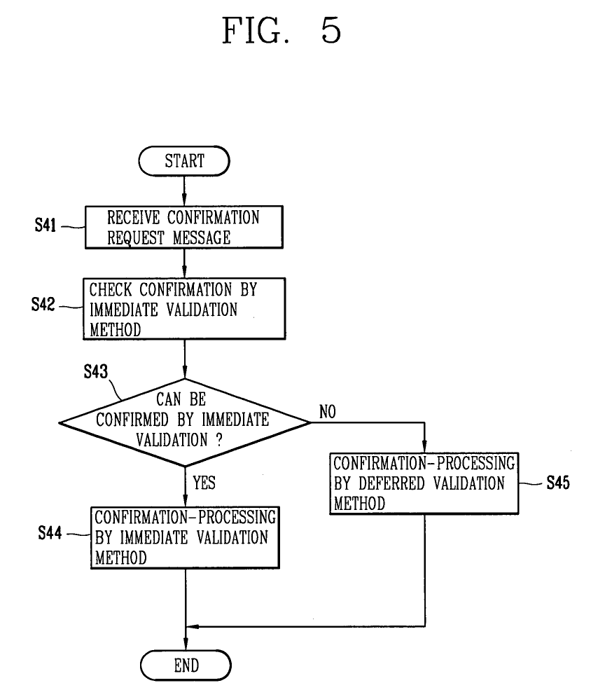

FIG. 5 is a flow chart of a method for processing a read-only mobile transaction by the mobile client in accordance with the present invention.

Referring to FIG. 5, the transaction execution module 11 of the mobile client 10 executes the read-only mobile transaction and generates a confirmation request message. When the confirmation module 14 of the mobile client 10 receives the confirmation request message (S41), it checks whether the read-only mobile transaction can be confirmed by the immediate validation method (S42).

The confirmation module 14 checks whether the cache time stamps of all the data included in the reading set of the executed read-only mobile transaction have the same value (S43). If the cache time stamps of all the data included in the reading set have the same value, the confirmation module 14 immediately confirms the executed read-only mobile transaction (S44).

If, however, the cache time stamps of all the data included in the reading set do not have the same value, the confirmation module 14 delays confirmation until the next IR message is received (S45). That is, the confirmation module 14 generates a confirmation request message for requesting confirmation of the read-only mobile transaction into a confirmation queue. The confirmation request message includes an identity (ID) of the read-only mobile transaction and a reading set of the transaction.

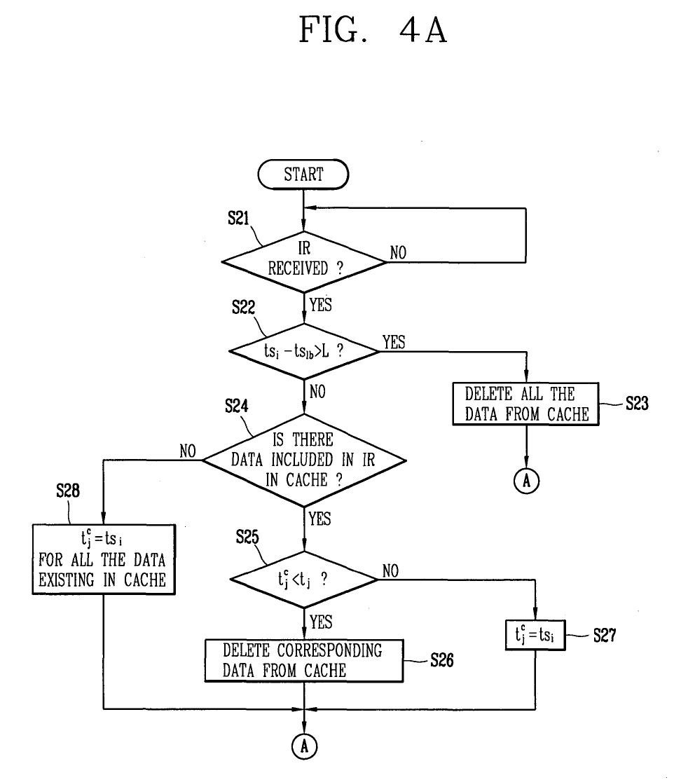

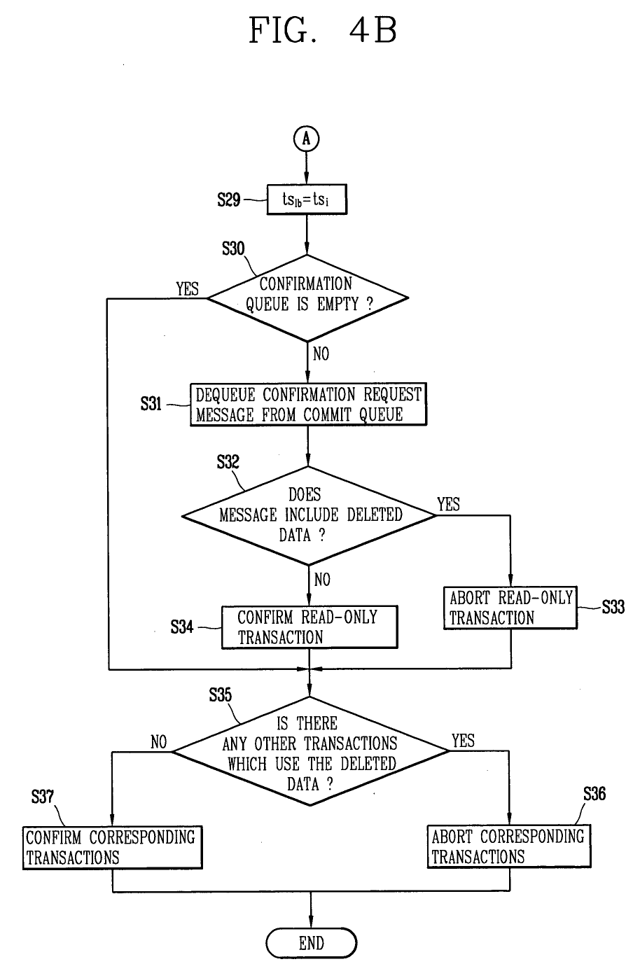

Referring to FIGS. 4A and 4B, when a mobile client 10 receives an IR message which is periodically broadcasted by a mobile server 20 (S21), the cache invalidation module 12 of the mobile client 10 checks whether a difference between the broadcast time stamp (tsᵢ) of the received IR message (IR(tsᵢ)) and the last IR time stamp ts_{lb} stored in the mobile client 10 is greater than ‘L’ (a broadcast period) (S22).

If the difference is greater than ‘L’, that is, if the IR message has been received after a predetermined time lapse, the cache invalidation module 12 deletes all the data stored in the cache (S23). If, however, the difference is not greater than ‘L”, that is, if the cache invalidation process 12 receives the IR message timely, the cache invalidation process 12 checks whether there is the same data with the data contained in the IR message in the cache (S24).

If the received data is not the same as the data contained in the IR message in the cache, the cache invalidation module 12 assigns the cache time stamps of all the data existing in the cache as a broadcast time stamp (S28). In this manner, by updating the cache time stamp for the data which has not been invalidated, the mobile client can perform the confirmation process of the read-only mobile transaction, independently.

If, however, the received data is the same as the data contained in the IR message in the cache, the cache invalidation module 12 checks whether the update time stamp (tⱼ) of the data contained in the IR message is greater than the cache time stamp (t^{c}ⱼ) of the corresponding data existing in the cache (S25).

If the update time stamp (tⱼ) is greater than the cache time stamp (t^{c}ⱼ), the cache invalidation module 12 deletes the corresponding data from the cache to invalidate it (S26).

If, however, the update time stamp (tⱼ) is not greater than the cache time stamp (t^{c}ⱼ), the cache invalidation module 12 assigns the cache time stamp (t^{c}ⱼ) as a broadcast time stamp (tsᵢ) of the IR message (S27). The cache invalidation process 12 assigns ts_{lb} as the broadcast time stamp (tsᵢ) (S29). And then, the confirmation module 14 checks whether a confirmation queue is empty (S30). If the confirmation queue is not empty, the confirmation module 14 dequeues a confirmation request message from the confirmation queue (S31).

If the dequeued confirmation request message contains a data which has been deleted from the cache by the cache invalidation process 12, the confirmation module 14 withdraws the read-only mobile transaction contained in the confirmation request message (S33).

If, however, the dequeued confirmation request message does not contain the deleted data, the confirmation module 14 confirms the read-only mobile transaction contained in the confirmation request message (S34).

In this manner, the confirmation module 14 receives the next IR message, a cache invalidation is performed with the IR message by the cache invalidation module 12, and then, a delay validation confirmation process is performed based on the cache invalidation processing result.

After the delay validation confirmation processing is performed, the cache consistency checking/maintaining module 13 checks whether there are other transactions using a data which has been deleted from the cache by the cache invalidation module 12 (S35). If there are other transactions using the deleted data, the cache consistency checking/maintaining module 13 withdraws the corresponding transactions (S36).

In this manner, whenever IR messages are received, the mobile client 10 periodically performs the cache invalidation processing and the processing to maintain the consistency of the cache data. As so far described, the system and method for maintaining transaction cache consistency in a mobile computing environment has the following advantages:

First, by applying the optimistic concurrency control with update timestamp span (OCC-UTS²) protocol to the read-only mobile transaction, the serial execution of the read-only mobile transaction is guaranteed, the consistency of the cache data of the mobile client can be maintained, and the mobile client can perform the confirmation processing of the read-only mobile transaction independently.

Second, since the mobile client checks the consistency of the transaction cache data on the basis of the time stamp and performs the transaction confirmation processing independently, the load of the mobile server can be distributed and the transmission and reception message between the mobile server and the mobile client can be minimized.

Third, in processing the read-only mobile transaction by the mobile client, the message transmission and reception for controlling concurrency between the mobile server and the mobile client are completely removed. Thus, the bandwidth for the radio interface can be effectively used.

Fourth, since the mobile server assigns the same update time stamp to the data, one transaction is updated and the mobile client withdraws all the transactions which use invalidated data, a consistency between multiple data, can be maintained.

Fifth, since the mobile client performs the mobile transaction confirmation processing on the basis of the time stamp, a fast transaction response time can be provided.

Sixth, whenever the IR message is received by the mobile client, the cache time stamp is updated by using the IR message even for a data of a cache which has not been invalidated. Thus, the cache consistency of the mobile client can be maintained.

Finally, since the mobile server provides the time stamp together with the data, even if the mobile client immediately caches the data, the cache consistency can be maintained and serial execution of the transaction can be guaranteed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A mobile client terminal for maintaining transaction cache consistency in a mobile communication network, the mobile client terminal in communication with a mobile server configured to periodically broadcast an invalidation report (IR) message, wherein the mobile client terminal updates data stored in a transaction cache based upon information included in the IR message, and confirms execution of a transaction.

2. The mobile client terminal of claim 1, comprising:
a transaction execution module for executing the transaction;
a cache invalidation module for updating the transaction cache based on the information included in the IR message;
a cache consistency module for maintaining transaction cache consistency by canceling transactions which are invalid according to the information included in the IR message; and
a confirmation module for confirming or delaying execution of the transaction, depending on a time stamp of data accessed by the transaction execution module.

3. The mobile client terminal of claim 1, wherein the mobile server comprises:
an IR module for periodically broadcasting the IR message; and
a data set providing module for providing data to the mobile client terminal in response to an immediate caching request from the mobile client.

4. The mobile client terminal of claim 1, wherein the IR message comprises:
a broadcast time stamp for indicating a broadcast time;
updated data; and
an update time stamp of a transaction confirming the updated data.

5. The mobile client terminal of claim 1, wherein at least one data is associated with the transaction, the data having a time stamp, wherein:
if the data associated with the transaction has a time stamp identical to time stamps of other data associated with the transaction, the mobile client terminal immediately confirms the transaction; and
if the data associated with the transaction does not have a time stamp identical to time stamps of other data associated with the transaction, the mobile client terminal defers confirming the transaction until another IR message received by the mobile client.

6. The mobile client terminal of claim 1, wherein data stored in the transaction cache is associated with a cache time stamp, and wherein if execution of the transaction updates the data, the mobile server updates the cache time stamp.

7. A method for maintaining transaction cache consistency for a mobile terminal in a mobile communication environment, comprising the steps of:
executing a read-only transaction that requests data;
updating data stored in a cache of the mobile terminal in response to receiving an invalidation report (IR) message; and
confirming the executed read-only transaction.

8. The method of claim 7, wherein the IR message is periodically broadcast by a mobile server, wherein the IR message comprises:
a broadcast time stamp;
updated data; and
an update time stamp associated with the updated data.

9. The method of claim 8, wherein the update time stamp indicates when the updated data was last confirmed.

10. The method of claim 7, wherein the step of updating data stored in the cache comprises:
deleting data stored in the cache, if the IR message is not received within a broadcast period;
comparing an update time stamp of data received in the IR message with a cache time stamp of corresponding data stored in the cache, if the data received in the IR message is already stored in the cache and the IR message is received within the broadcast period; and
replacing data stored in the cache with the data received in the IR message and associating with the data received in the IR message a cache time stamp equal to a broadcast time stamp of the IR message, if the update time stamp of the data received is after the cache time stamp of corresponding data stored in the cache.

11. The method of claim 7, further comprising preventing execution of the read-only transaction associated with data invalidated in accordance with the IR message.

12. The method of claim 7, wherein the step of confirming comprises:
determining whether all data requested by the read-only transaction have equal cache time stamps,
immediately confirming the read-only transaction, if all data have equal cache time stamps; and
delaying confirmation of the read-only transaction until a second IR message is received, if all data do not have equal cache time stamps.

13. The method of claim 7, further comprising:
confirming the read-only transaction, if the read-only transaction does not include data invalidated based on the IR message; and
canceling the read-only transaction, if the read-only transaction includes data invalidated based on the IR message.

14. A method for updating transaction cache consistency in a mobile communication environment, the method comprising the steps of:
periodically broadcasting an invalidation report (IR) message from a mobile server to a mobile client; and
executing a read-only transaction, comprising a request for data, by using an optimistic concurrency control with timestamp span (OCC-UTS²) protocol.

15. The method of claim 14, wherein the step of executing the read-only transaction comprises:
determining whether requested data is stored in a transaction cache;
processing the requested data in the transaction cache, if the requested data is stored in the cache; and
retrieving the requested data from a mobile server, if the requested data is not stored in the transaction cache.

16. The method of claim 15, wherein the requested data stored in the transaction cache is associated with a cache time stamp, the method further comprising:
receiving an IR message associated with the requested data, wherein the IR message includes corresponding data associated with an update time stamp;
selecting the requested data stored in the transaction cache, if the update time stamp matches the cache time stamp; and
waiting to receive another IR message, if the update time stamp does not match the cache time stamp.

17. The method of claim 16, further comprising:
replacing data stored in the transaction cache with the corresponding data in the IR message, if the corresponding data included in the IR message is associated with an update time stamp that is after the cache time stamp associated with the data stored in the cache.

18. The method of claim 14, further comprising:
confirming the read-only transaction immediately, if all data requested by the executed read-only transaction have same cache time stamps; and
delaying confirming the read-only transaction until another IR message is received, if all data requested by the executed read-only transaction do not have the same cache time stamps.

19. The method of claim 16, further comprising:
confirming a read-only transaction, if the read-only transaction does not request invalidated data, according to a received IR message; and
canceling a read-only transaction, if the read-only transaction requests invalidated data, according to a received IR message.

20. The method of claim 16, further comprising updating the transaction cache when an IR message is received.

21. A mobile communication network comprising mobile server and mobile client terminals in communication with each other in at least one cell of the mobile communication network, wherein each mobile client terminal comprises a transaction cache, and wherein the transaction cache comprises data associated with a cache time stamp, the mobile client terminal comprising logic code embedded in a recording medium for execution by a microcontroller, wherein the execution of the logic code causes the microcontroller to perform:
receiving a request for data to be used in a transaction;
determining whether the data is stored in the transaction cache;
using the data if the data is stored in the transaction cache to execute the transaction, wherein the data stored in the transaction cache is associated with a cache time stamp;
retrieving the data from the mobile server, if the data is not stored in the transaction cache, and storing the data in the transaction cache in association with a corresponding cache time stamp;
determining if an invalidation report (IR) message includes validation information associated with the data, the validation information including an update time stamp associated with the data;
validating the data as stored in the cache, if the update time stamp is before the cache time stamp; and
updating the requested data, if the update time stamp is after the cache time stamp.
